(19) United States
(12) Patent Application Publication
(10) Pub. No.: US 2018/0253678 A1
(43) Pub. Date: Sep. 6, 2018

(54) INVENTORY ITEM MANAGEMENT SYSTEM, TRANSPORTING DEVICE AND THE METHOD FOR DOCKING WITH INVENTORY HOLDER

(71) Applicant: Zhejiang Guozi Robot Technology Co., Ltd., Hangzhou City, Zhejiang (CN)

(72) Inventors: Lei Wei, Hangzhou City, Zhejiang (CN); Yikun Tao, Hangzhou City, Zhejiang (CN); Hongbo Zheng, Hangzhou City, Zhejiang (CN); Lingfen Zhu, Hangzhou City, Zhejiang (CN); Xia Wang, Hangzhou City, Zhejiang (CN); Xinfeng Du, Hangzhou City, Zhejiang (CN); Zhenhua Shen, Hangzhou City, Zhejiang (CN)

(73) Assignee: Zhejiang Guozi Robot Technology Co., Ltd., Hangzhou City, Zhejiang (CN)

(21) Appl. No.: 15/305,270

(22) PCT Filed: Oct. 9, 2016
(86) PCT No.: PCT/CN2016/101606

§ 371 Date: May 7, 2018

(51) Int. Cl. G06Q 10/08; G05B 19/418; G05D 1/02; G01C 21/20

(52) U.S. Cl. CPC G06Q 10/087; G05B 19/41895; G05D 1/0223; G05B 19/4183; G01C 21/20; G05D 1/0225

(57) ABSTRACT

The present invention provides an inventory item management system, a transporting device and the method for docking with the carried object. The method for the transporting device docking with the carried object includes the following steps: acquiring the docking instruction for docking with the carried object within a work space; acquiring the coordinate of the carried object within the work space; acquiring the real time coordinate of the transporting device within the work space; setting the optimized path for the transporting device traveling to the carried object; distributing at least one travel instruction according to the optimized path; driving the transporting device to travel to the position of the carried object according to the travel instruction; and docking with the carried object.

### CROSS-REFERENCE TO RELATED APPLICATIONS

This application is the U.S. National Phase of PCT/CN2016/101606 filed Oct. 6, 2016 the entire content of which is incorporated herein by reference.

### FIELD OF THE INVENTION

The invention relates to the field of intelligent logistics, and in particular to an inventory item management system, a transporting device and the method for docking with the carried object.

### BACKGROUND OF THE INVENTION

In the modern logistics industry, the manpower cost has been rising over the years, the requirement for the logistics efficiency continues to increase, and the occurrence of the intelligent warehousing and intelligent transportation has become a major trend. With the development of the sensor technology and automatic control technology, unmanned automated transport vehicles and wheeled mobile robots have been popularized and applied in the logistics industry, among which the most typical one is the Automated Guided Vehicle (referred to as AGV). The AGVs are equipped with electromagnetic or optical automatic guidance devices, can travel along the prescribed guiding path, and have security protection and a variety of load transferring functions, pertaining to the category of wheeled mobile robots (referred to as WMR).

Lifting or articulating is generally used to implement docking of the transporting vehicle with the transported cargos in the process of carrying cargos in the warehouse using an AGV, and the requirement for the docking precision is quite high. As the cargos are placed on predetermined target positions with certain possible deviations, such that the technical problem that the precise docking of the transporting vehicle with the cargos cannot be realized exists when the cargos are carried again.

In prior art, the technical scheme of mechanically limiting the transported cargos is usually adopted, where the placement positions of the cargos are regulated by a special limiting device in the warehouse each time the cargos are put down, so that the positions of the cargos are not deviated; or, after each time the cargos are put down, the placement positions of the cargos are re-corrected by a special equipment in the warehouse, adjusting the deviated cargos to the correct positions, whereby the transporting vehicles merely need to travel to the warehouse in a way of absolute positioning so as to realize smooth docking with the cargos. The deficiencies of such methods lie in that every freight space needs a special limiting equipment or adjustment equipment, which occupies a large amount of storage space and increases the fundamental infrastructure cost of the warehouse greatly; in the meantime, the requirement for the standardization level is high, and no deviation is allowed during the driving of the transporting vehicle, thus the docking flexibility and anti-interference ability are poor.

In prior art, there is another type of technical scheme which adopts the method for correcting the position of the vehicle body after detecting deviations, which provides a plurality of sensors (such as distance sensors etc.) on the body of the transporting vehicle, using the sensors to detect if deviations exist between the cargos and the target positions. Since the effective distance of the sensor is relatively short, the sensor is only effective when coming close to the cargos, therefore, the time for adjusting the travel direction of the vehicle body is rather short and a better docking path cannot be regulated in advance when deviations are detected between the body of the transporting vehicle and the target positions and the transporting vehicle is found not to be able to smoothly dock with the cargos. The distance of deviation can only be calculated by the transporting vehicle itself, and the position of the vehicle body is re-adjusted and the docking is then tried again. The deficiencies of such method lie in that it is rather difficult for the transporting vehicle to adjust the position of the vehicle body within a small space, resulting in low work efficiency and interfering normal operation of other transporting vehicles. If more than two adjacent freight spaces need to adjust the position of the vehicle bodies simultaneously to realize docking, the carrying efficiency would be even lower. Besides, such schemes require a sensor group provided for each transporting vehicle, the hardware costs thereof are therefore higher.

### SUMMARY OF THE INVENTION

It is an object of the present invention to solve the technical problems existing in prior art, which are the docking of the transporting device with the carried object being not precise, poor flexibility, lower work efficiency, occupying too much space and high facility costs, and the like.

In order to achieve the above object, the invention provides a method for docking a transporting device with a carried object, wherein the method comprises the following steps: acquiring a docking instruction for docking a carried object within a work space; acquiring a coordinate of the carried object within the work space; acquiring a real time coordinate of the transporting device within the work space; setting an optimized path for the transporting device traveling to the carried object; distributing at least one travel instruction according to the optimized path; driving the transporting device to travel to the position of the carried object according to the travel instruction; and docking with the carried object. Further, comprising the following steps before the step of acquiring a coordinate of the carried object: providing at least one fiducial mark on at least one carried object; providing at least one fiducial mark identification device distributed within the whole work space; identifying the fiducial mark and acquiring the coordinate of the carried object, and storing the coordinate of the carried object into a position management system. The fiducial mark is provided on the top of the carried object; the fiducial mark identification device is provided on the top of the work space, which can be fixed independently or mounted to a pan/tilt, located above the top of the carried object. The fiducial mark is a readable code; preferably a two-dimensional code or a bar code. The fiducial mark identification device is a visual sensor.

Further, comprising the following steps before the step of acquiring the coordinate of the carried object: providing at least one image identification device distributed within the whole work space; acquiring original information of the carried object; acquiring the coordinate of at least one carried object according to the original information of the carried object; and storing the coordinate of the carried object into a position management system. The image identification device is provided on the top of the work space, which can be fixed independently or mounted to a pan/tilt, located above the top of the carried object. The image identification device is a visual sensor; and the original information is at least one image data.

Further, the step of acquiring a real time coordinate of the transporting device refers to acquiring a real time coordinate of the transporting device using laser navigation, magnetic navigation or visual navigation.

Further, the step of setting an optimized path for the transporting device traveling to the carried object specifically comprises the following steps: invoking a topological map of a work space; the topological map comprising geometrical information and connection relation information of travelable routes within the work space; acquiring the topological positions of the carried object and the transporting device on the topological map; and calculating the optimized path for the transporting device traveling to the carried object according to the topological positions of the carried object and the transporting device, and the geometrical information and connection relation information of the travelable routes.

Further, the step of distributing at least one travel instruction according to the optimized path specifically comprises the following steps: acquiring a relative position relation between the transporting device and the optimized path according to a real time coordinate of the transporting device and the optimized path; calculating at least one travel instruction according to the relative position relation; the travel instruction comprising a speed instruction and an angular speed instruction, or, comprising a speed instruction and a turning radius instruction; and distributing the travel instruction to a driving unit.

Further, the step of driving the transporting device to travel to the carried object according to the travel instruction specifically comprises the following steps: adjusting the speed of the transporting device during traveling according to a speed instruction; and adjusting the angular speed of the transporting device during traveling according to an angular speed instruction; or adjusting the turning radius of the transporting device during traveling according to a turning radius instruction.

Further, in the step of docking with the carried object, the transporting device is docked with the carried object by lifting; and/or is docked with the carried object by articulating.

In order to achieve the above object, the invention provides a method for docking the transporting device with the carried object as claimed in claim 1, wherein the method comprises the following steps after the step of docking with the carried object: acquiring a transport instruction for transporting the carried object to a target position within the work space; acquiring a coordinate of the target position; setting a second optimized path for the transporting device traveling from the position of the carried object to the target position; distributing at least one second travel instruction according to the second optimized path; driving the transporting device to travel to the target position according to the second travel instruction; and detaching the carried object.

Further, the step of setting a second optimized path for the transporting device traveling from the position of the carried object to the target position specifically comprises the following steps: invoking a topological map of a work space, the topological map comprising geometrical information and connection relation information of at least one travelable route within the work space; acquiring the topological positions of the transporting device and the target position on the topological map; and calculating a second optimized path for the transporting device traveling to the target position according to the topological positions of the transporting device and the target position, and the geometrical information and connection relation information of the travelable routes.

Further, the step of distributing at least one travel instruction according to the second optimized path specifically comprises the following steps: acquiring a relative position relation between the transporting device and the second optimized path according to a real time coordinate of the transporting device and the second optimized path; calculating at least one second travel instruction according to the relative position relation; the second travel instruction comprising a speed instruction and an angular speed instruction, or, comprising a speed instruction and a turning radius instruction; and distributing the second travel instruction to a driving unit.

Further, the step of driving the transporting device to travel to the position of the carried object according to the second travel instruction specifically comprises the following steps: adjusting the speed of the transporting device during traveling according to a speed instruction in the second travel instruction; and adjusting the angular speed of the transporting device during traveling according to an angular speed instruction in the second travel instruction; or adjusting the turning radius of the transporting device during traveling according to a turning radius instruction in the second travel instruction.

Further, the work space comprises but not limited to a warehouse; the carried object comprises but not limited to an inventory holder or a tray; the transporting device comprises but not limited to an automated guided vehicle or a mobile robot.

In order to achieve the above object, the invention provides a transporting device and an inventory item management system. Wherein, the transporting device comprises a control unit, a driving unit and a docking unit.

The control unit is used for acquiring a docking instruction for docking a carried object within a work space; acquiring a coordinate of the carried object; acquiring a real time coordinate of the transporting device; setting an optimized path for the transporting device traveling to the carried object; and distributing at least one travel instruction according to the optimized path; the driving unit is used for driving the transporting device to travel to the carried object according to the travel instruction; the docking unit is used for docking with the carried object.

Further, the control unit is also used for acquiring a transport instruction for transporting the carried object to a target position within the work space; acquiring a coordinate of the target position; setting a second optimized path for the transporting device traveling from the position of the carried object to the target position; distributing at least one second travel instruction according to the second optimized path. The driving unit is also used for driving the transporting device to travel to the target position according to the second travel instruction; and the docking unit is also used for detaching the carried object.

Further, the control unit comprises a navigation unit, a communication unit, a route calculation unit and an instruction unit. The navigation unit is used for acquiring a real time coordinate of the transporting device; the communication unit is used for acquiring the docking instruction and/or the transport instruction, and acquiring a coordinate of the carried object and/or a coordinate of the target position; the route calculation unit is used for setting the optimized path according to the coordinate of the carried object and a real time coordinate of the transporting device; or, setting the second optimized path according to the coordinate of the carried object and the coordinate of the target position; the instruction unit is used for sending the travel instruction to the driving unit according to the optimized path; or, sending the second travel instruction to the driving unit according to the second optimized path.

Further, the navigation unit comprises but not limited to a laser navigation unit, a magnetic navigation unit or a visual navigation unit.

Further, the route calculation unit comprises a topological map invoking unit, a topological position acquisition unit and an optimized path calculation unit. The topological map invoking unit is used for invoking a topological map of a work space; the topological map comprises geometrical information and connection relation information of at least one travelable route within the work space. The topological position acquisition unit is used for acquiring the topological positions of the carried object or the target position and the transporting device on the topological map. The optimized path calculation unit is used for calculating the optimized path for the transporting device traveling to the carried object according to the topological positions of the carried object and the transporting device, and the geometrical information and connection relation information of the travelable routes; or, calculating a second optimized path for the transporting device traveling to the target position according to the topological positions of the target position and the transporting device, and the geometrical information and connection relation information of the travelable routes.

Further, the instruction unit comprises a relative position acquisition unit, a travel instruction calculation unit and a travel instruction distribution unit. The relative position acquisition unit is used for acquiring a relative position relation between the transporting device and the optimized path according to a real time coordinate of the transporting device and the optimized path; or, acquiring a relative position relation between the transporting device and the second optimized path according to a real time coordinate of the transporting device and the second optimized path.

The travel instruction calculation unit is used for calculating at least one travel instruction or second travel instruction according to the relative position relation; the travel instruction or the second travel instruction comprises a speed instruction and an angular speed instruction, or, comprises a speed instruction and a turning radius instruction; and the travel instruction distribution unit is used for distributing the travel instruction or the second travel instruction to a driving unit.

Further, the driving unit comprises a speed adjustment unit, and also comprises an angular speed adjustment unit or a turning radius adjustment unit. The speed adjustment unit is used for adjusting the speed of the transporting device during traveling according to a speed instruction; and the angular speed adjustment unit is used for adjusting the angular speed of the transporting device during traveling according to an angular speed instruction; the turning radius adjustment unit is used for adjusting the turning radius of the transporting device during traveling according to a turning radius instruction.

Further, the docking unit comprises a lifting device and/or an articulating device; the lifting device is used for docking with the carried object by lifting; the articulating device is used for docking with the carried object by articulating.

Further, the work space comprises but not limited to a warehouse; the carried object comprises but not limited to an inventory holder or a tray; the transporting device comprises but not limited to an automated guided vehicle or a mobile robot.

Wherein, the inventory item management system comprises a work space; a transporting device as described above; a system controller, at least one carried object and at least one carried object identification device and a position management system. The system controller is connected to a communication unit of the transporting device; used for distributing the docking instruction and/or the transport instruction to the communication unit. The carried object is located within the work space; the carried object identification devices are distributed within the whole work space, used for identifying the coordinate of at least one carried object. The position management system is connected to the carried object identification device and the communication unit, used for storing the coordinate of the carried object and sending the coordinate of the carried object to the communication unit.

Further, each carried object is provided with at least one fiducial mark; the carried object identification device is a fiducial mark identification device, used for identifying the fiducial mark, and acquiring the coordinate of at least one carried object according to the information carried by the fiducial mark. The fiducial mark is provided on the top of the carried object; the fiducial mark identification device is provided on the top of the work space, which can be fixed independently or mounted to a pan/tilt, located above the top of the carried object. The fiducial mark is a readable code, preferably a two-dimensional code or a bar code; the fiducial mark identification device is a visual sensor.

Further, the carried object identification device is an image identification device, used for acquiring original information of the carried object; and acquiring the coordinate of at least one carried object according to the original information of the carried object. The image identification device is provided on the top of the work space, which can be fixed independently or mounted to a pan/tilt, located above the top of the carried object. The image identification device is a visual sensor; and the original information is at least one image data.

The advantages of the invention lie in that: a plurality of evenly distributed visual sensors (such as cameras) are provided within the work space (such as a warehouse) to precisely identify the real coordinate of each carried object; a position management system is provided, enabling each carried object to be identified and the real coordinate thereof to be stored at the same time when it is put down within the work space (such as a warehouse), so that the transporting device (such as an AGV) can invoke at any time the position of a certain carried object that needs to be carried when required, that the transporting device has sufficient time to set its optimized path, and that the transporting device can automatically adjust direction during traveling to precisely find the carried object. In the whole process, there is no need for precise limit of the carried object, in that even if the position of the carried object is rather deviated from the predetermined position, docking can be smoothly realized in one time without the need of repeated adjustment of the position of the transporting device near the carried object.

### BRIEF DESCRIPTION OF THE DRAWINGS

FIG. 1 is a structural schematic view of the inventory item management system in Embodiment 1 of the present invention;

FIG. 2 is a functional modular diagram of the inventory item management system in Embodiment 1 of the present invention;

FIG. 3 is a flow diagram of the method for docking the transporting device with the carried object in Embodiment 1 of the present invention;

FIG. 4 is a flow diagram of the method for optimizing the path for the transporting device traveling to the carried object in Embodiment 1 of the present invention;

FIG. 5 is a flow diagram of the method for distributing a travel instruction to the driving unit in Embodiment 1 of the present invention;

FIG. 6 is a flow diagram of the method for driving the transporting device to travel to the position of the carried object in Embodiment 1 of the present invention;

FIG. 7 is a flow diagram of the method for acquiring the coordinate of the carried object in Embodiment 1 of the present invention;

FIG. 8 is a structural schematic view of the inventory item management system in Embodiment 2 of the present invention;

FIG. 9 is a flow diagram of the method for acquiring the coordinate of the carried object in Embodiment 2 of the present invention;

FIG. 10 is a flow diagram of the method for docking the transporting device with the carried object in Embodiment 3 of the present invention;

FIG. 11 is a flow diagram of the method for setting a second optimized path for the transporting device traveling from the position of the carried object to the target position in Embodiment 3 of the present invention;

FIG. 12 is a flow diagram of the method for distributing a second travel instruction to the driving unit in Embodiment 3 of the present invention;

FIG. 13 is a flow diagram of the method for driving the transporting device to the target position according to the second travel instruction in Embodiment 3 of the present invention.

### LIST OF REFERENCE NUMERALS

1 Work space
2 Transporting device
3 Carried object
4 Carried object identification device
5 System controller
6 Position management system
21 Control unit
22 Driving unit
23 Docking unit
31 Fiducial mark
41 Fiducial mark identification device
42 Image identification device
221 Speed adjustment unit
222 Angular speed adjustment unit
2131 Topological map invoking unit
2132 Topological position acquisition unit
2133 Optimized path calculation unit
2141 Relative position acquisition unit
2142 Travel instruction calculation unit
2143 Travel instruction distribution unit

### DETAILED DESCRIPTION OF THE PREFERRED EMBODIMENTS

Now, the technical contents of the present invention are made clearer and to be clearly understood, three preferred embodiments are introduced below in conjunction with the accompanying drawings. The present invention is embodied in various different forms, and the protection scope of the invention is not limited to the embodiments mentioned herein.

In the accompanying drawings, components with identical structure are represented by the same reference numerals, and members with similar structures or functions are represented by similar reference numerals. The size and thickness of each member shown in the drawings are randomly illustrated, and the invention does not limit the size and thickness of each member. For clarity of the drawings, in some places of the drawings the thicknesses of the components are properly exaggerated.

When some members are described as “to be” “on” another member, said member can be directly disposed on said another member, or, there could be an intermediate member and said member is disposed on said intermediate member, and said intermediate member is disposed on said another member. When a member is described as to be “mounted to” or “connected to” another member, the two can be understood as to be directly “mounted” or “connected”, or, one member is indirectly “mounted to” or “connected to” another member through an intermediate member.

### Embodiment 1

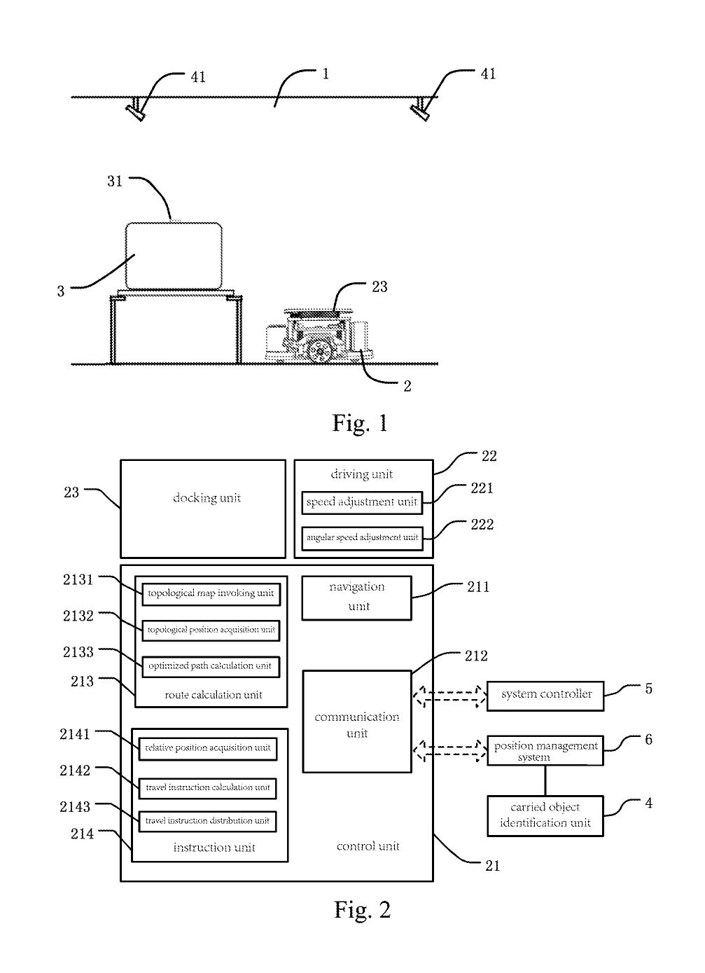

As shown in FIG. 1, Embodiment 1 provides an inventory item management system, including a work space 1, a transporting device 2, at least one carried object 3, at least one carried object identification device 4, a system controller 5, and a position management system 6.

Work space 1 is an independent space for storing or transferring at least one carried object 3. In the present embodiment, work space 1 is preferably a warehouse for cargos storage and transferring cargos. Carried object 3 is preferably an inventory holder or tray for placing and storing cargos, and can also be a package of cargos. Carried object identification devices 4 are distributed within the whole work space, forming a monitoring network used for identifying the coordinate of at least one carried object 3. Carried object identification devices 4 can be evenly distributed within the whole work space, any two adjacent carried object identification devices can be arranged at equal intervals. Each of carried object identification devices 4 corresponds to at least one carried object 3 or warehouse for placing carried object 3. Position management system 6 is used for storing the coordinate of at least one carried object 3, and sending the coordinate of carried object 3 to transporting device 2 according to requirements. System controller 5 is used for distributing docking instruction for docking with carried object 3 within work space 1, and after transporting device 2 receives the docking instruction, transporting device 2 travels to the position of carried object 3 within work space 1 and docks with carried object 3.

As shown in FIG. 2, transporting device 2 includes a control unit 21, a driving unit 22 and a docking unit 23. In the present embodiment, transporting device 2 is preferably an automated guided vehicle (AGV) or a mobile robot. Transporting device 2 has generally two controllers, typically called as interior controller and exterior controller (ground controller). The interior controller is control unit 21, and the exterior controller is system controller 5.

Control unit 21 is used for acquiring the docking instruction for docking with carried object 3 within work space 1; acquiring the coordinate of carried object 3; acquiring the real time coordinate of transporting device 2; setting the optimized path for transporting device 2 traveling to carried object 3; distributing at least one travel instruction according to the optimized path. Control unit 21 includes a navigation unit 211, a communication unit 212, a route calculation unit 213 and an instruction unit 214.

Navigation unit 211 includes but not limited to a laser navigation unit, a magnetic navigation unit or a visual navigation unit, used for acquiring the real time coordinate of transporting device 2.

Communication unit 212 is a radio communication module, including but not limited to a WLAN communication module, blue-tooth communication module, and cellular communication module. Communication unit 212 is used for acquiring the docking instruction, acquiring the coordinate of carried object 3.

Route calculation unit 213 is used for setting the optimized path according to the coordinate of carried object 3 and a real time coordinate of transporting device 2; sending the travel instruction to driving unit 22 according to the optimized path. Route calculation unit 213 includes a topological map invoking unit 2131, a topological position acquisition unit 2132 and an optimized path calculation unit 2133. Topological map invoking unit 2131 is used for invoking a topological map of work space 1; the topological map comprising geometrical information and connection relation information of at least one travelable route within work space 1. Topological position acquisition unit 2132 is used for acquiring the topological positions of carried object 3 and transporting device 2 on the topological map. Optimized path calculation unit 2133 is used for calculating the optimized path for transporting device 2 traveling to carried object 3 according to the topological positions of carried object 3 and transporting device 2, and the geometrical information and connection relation information of the travelable routes.

According to the principle of the automated guided vehicle (AGV), any kind of navigation method in the prior art can be utilized to plan a travel path for a vehicle body as long as the start point and the end point of the transporting vehicle are known. In the present embodiment, 2 degrees of freedom of AGV are preferably selected, preferably scenarios with maps, suited for situations with multiple AGVs operating together.

Instruction unit 214 is used for sending the travel instruction to driving unit 22 according to the optimized path; instruction unit 214 comprises a relative position acquisition unit 2141, a travel instruction calculation unit 2142 and a travel instruction distribution unit 2143. Relative position acquisition unit 2141 is used for acquiring a relative position relation between transporting device 2 and the optimized path according to a real time coordinate of transporting device 2 and the optimized path. Travel instruction calculation unit 2142 is used for calculating at least one travel instruction according to the relative position relation. The travel instruction comprises a speed instruction and an angular speed instruction, or, comprises a speed instruction and a turning radius instruction. Travel instruction distribution unit 2143 is used for distributing the travel instruction to a driving unit 22. Driving unit 22 is used for driving transporting device 2 to travel to carried object 3 according to the travel instruction. Driving unit 22 comprises a speed adjustment unit 221, and also comprises an angular speed adjustment unit 222 or a turning radius adjustment unit (not shown in figures). Speed adjustment unit 221 is used for adjusting the speed of transporting device 2 during traveling according to a speed instruction; and angular speed adjustment unit 222 is used for adjusting the angular speed of transporting device 2 during traveling according to an angular speed instruction; the turning radius adjustment unit (not shown in figures) is used for adjusting the turning radius of transporting device 2 during traveling according to a turning radius instruction. There is no sequence for the speed adjustment, angular speed adjustment and turning radius adjustment, and it is decided specifically depending on the situation of the optimized path that which module is required to operate.

Docking unit 23 comprises a lifting device and/or an articulating device, for docking with carried object 3. The lifting device is used for docking with carried object 3 by lifting; the articulating device is used for docking with carried object 3 by articulating. The lifting device is preferable in the present embodiment.

As shown in FIG. 1, each carried object 3 is provided with at least one fiducial mark 31; fiducial mark 31 is provided on the top of carried object 3. Carried object identification device 4 can be a fiducial mark identification device 41, used for identifying fiducial mark 31, and acquiring the coordinate of at least one carried object 3 according to the information carried by fiducial mark 31. Fiducial mark identification device 41 is provided on the top of work space 1, which can be fixed independently or mounted to a pan/tilt (not shown), located above the top of carried object 3.

Fiducial mark 31 is preferably an encryptable two-dimensional code, and can also be other readable code available for locating, such as a bar code, etc. Fiducial mark identification device 41 is preferably a visual sensor (camera). The visual sensor includes a lens, which is located above carried object 3 and can read the two-dimensional code or bar code on the top of the cargos. In the present embodiment, the two-dimensional code carries information about the carried object, including the position coordinate of the carried object, and also the shape, volume, type, and code of the carried object. The visual sensor reads the two-dimensional code on the top of the cargos, and can obtain the position coordinate of the carried object directly. A plurality of fiducial mark identification devices 41 are provided high above, covering the whole work space 1, ensuring that the fiducial mark identification devices 41 can identify carried object 3 without dead angle no matter where carried object 3 is located within work space 1. As each visual sensor can cover a certain space, only a small amount of sensors can cover the entire warehouse, implementing effective monitoring of the position of the cargo.

System controller 5 is connected to communication unit 212 of transporting device 2, used for distributing the docking instruction to communication unit 212. Said docking instruction includes the information of carried object 3, such as code, shape, etc.

Position management system 6 is connected to carried object identification device 41, communication unit 212, used for acquiring and storing the coordinate of carried object 3 from carried object identification device 41, and sending the coordinate of carried object 3 to communication unit 212.

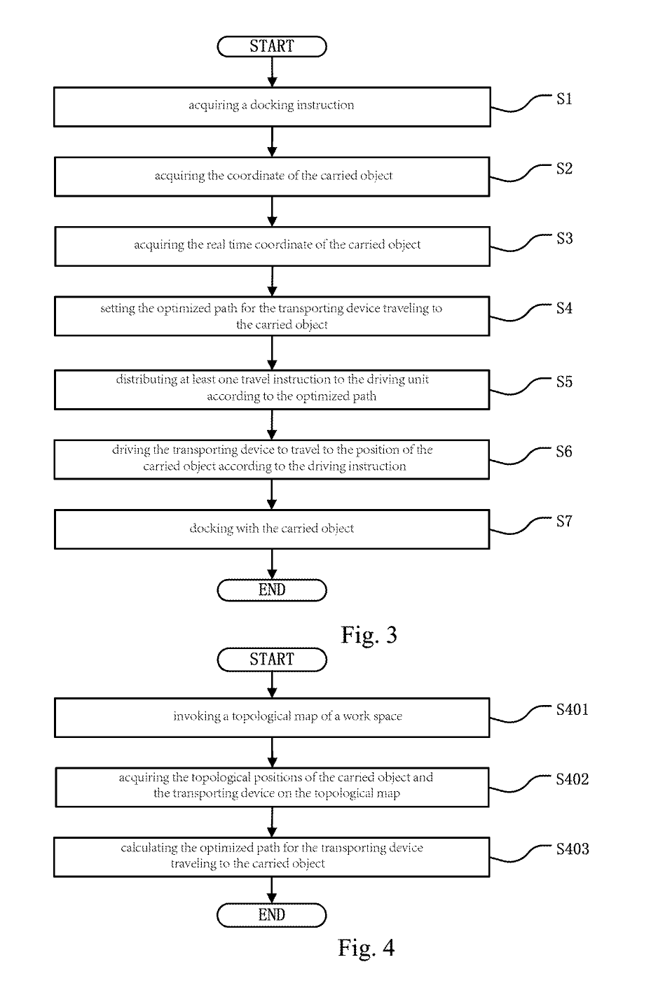

As shown in FIG. 3, the present invention also provides a method of docking the transporting device with the carried object, including the following steps:

Step S1) acquiring a docking instruction for docking a carried object within a work space; said docking instruction is distributed by system controller 5, and transporting device 2 acquires such a docking instruction from system controller 5 through communication unit 212; said docking instruction includes the information such as code, shape, etc. of carried object 3.

Step S2) acquiring a coordinate of the carried object within the work space. Position management system 6 is connected to fiducial mark identification device 31, acquiring and storing the coordinates of all carried objects 3 within work space 1. The coordinates of carried objects 3 are sent to transporting device 2 when transporting device 2 needs to invoke the coordinates of carried objects 3.

Step S3) acquiring a real time coordinate of the transporting device within the work space; specifically, acquiring the real time coordinate of the transporting device by way of laser navigation, magnetic navigation or visual navigation. Here step S2) and step S3) can be proceeded simultaneously, and also can be proceeded successively. As the coordinate of the carried object is static, the real time coordinate of the transporting device may change in real time (for example the transporting device is traveling when it receives the docking instruction), so the scheme of step S2 is preferably proceeded first, in order to avoid the error being too large and affecting the result of calculation.

Step S4) setting an optimized path for the transporting device traveling to the carried object; as shown in FIG. 4, specifically including the following steps: Step S401) invoking a topological map of a work space; the topological map comprising geometrical information and connection relation information of at least one travelable routes within the work space; Step S402) acquiring the topological positions of the carried object and the transporting device on the topological map according to the coordinates of the carried object and the transporting device within the work space; Step S403) calculating the optimized path for the transporting device traveling to the carried object according to the topological positions of the carried object and the transporting device, and the geometrical information and connection relation information of the travelable routes.

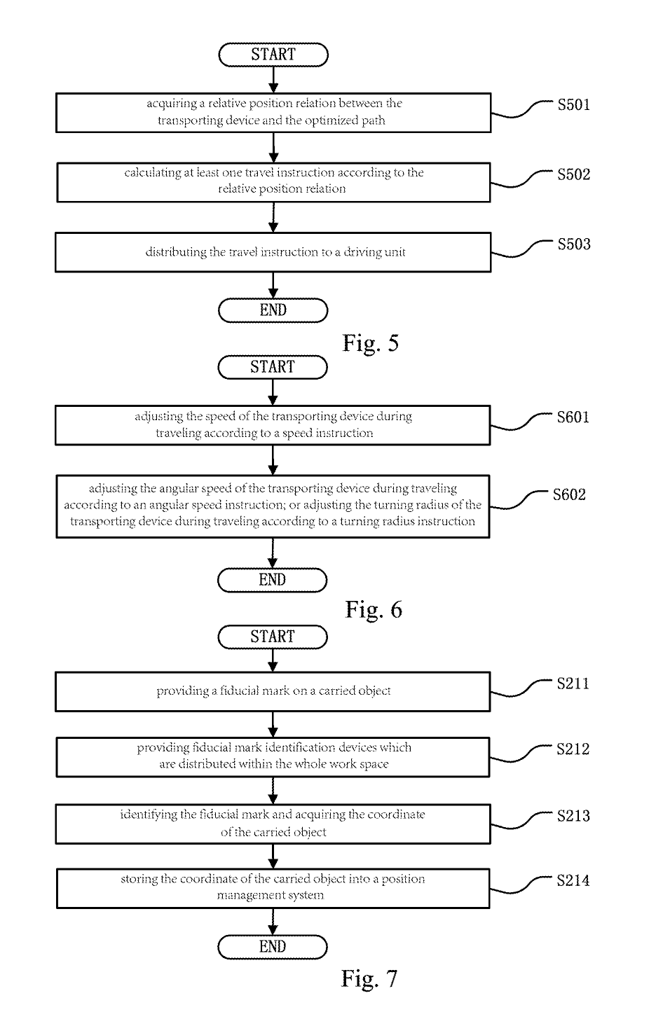

Step S5) distributing at least one travel instruction to a driving unit according to the optimized path; as shown in FIG. 5, specifically including the following steps: Step S501) acquiring a relative position relation between the transporting device and the optimized path according to a real time coordinate of the transporting device and the optimized path; Step S502) calculating at least one travel instruction according to the relative position relation; the travel instruction comprising a speed instruction and an angular speed instruction, or, comprising a speed instruction and a turning radius instruction; Step S503) distributing the travel instruction to the driving unit.

Step S6) driving the transporting device to travel to the position of the carried object according to the travel instruction; as shown in FIG. 6, specifically including the following steps: Step S601) adjusting the speed of the transporting device during traveling according to a speed instruction; Step S602) adjusting the angular speed of the transporting device during traveling according to an angular speed instruction; or adjusting the turning radius of the transporting device during traveling according to a turning radius instruction. Here Step S601-Step S602 are not sequenced in work, which can be proceeded simultaneously, and also can be proceeded successively according to specific situations.

Step S7) docking with the carried object, the transporting device is docked with the carried object by lifting; and/or is docked with the carried object by articulating.

The method of docking the transporting device with the carried object of the present invention also includes, before Step S2), a method for the position management system acquiring the coordinate of the carried object, as shown in FIG. 7, specifically including the following steps: Step S211) providing at least one fiducial mark on at least one carried object; Step S212) providing at least one fiducial mark identification device which is distributed within the whole work space; Step S213) identifying the fiducial mark and acquiring the coordinate of the carried object, including the coordinate of the carried object within the work space; Step S214) storing the coordinate of the carried object within the work space into a position management system. In Step S2, the position management system sends the coordinate of the carried object to the transporting device, and the transporting device acquires the coordinate of the carried object within the work space from the position management system.

Step S211)-Step S214) are actually the process of utilizing mark identification technology to acquire and store the coordinate of the carried object. In such a process, a plurality of evenly distributed visual sensors are provided high up in an independent space, which effectively identify the two-dimension codes on the top of each of the cargos in the warehouse, so as to acquire and store the coordinates of all cargos with the fastest speed to facilitate invoking and simultaneously updating the coordinate data at any time.

The technical effects of Embodiment 1 lie in that, providing an inventory item management system, a transporting device and a method for docking with the carried object, which utilize fiducial marks to proceed real-time monitoring of the position of the carried object, such that each carried object in the work space (such as a warehouse) is simultaneously identified and the real position thereof is stored when it is put down, facilitating the transporting device (such as an AGV) to invoke the position of a carried object that is required to be carried at any time when desired, so that the transporting device has sufficient time to set its optimized path. Embodiment 1 enables the transporting device to adjust direction autonomously during traveling, rather than traveling to the vicinity of the carried object and then adjusting direction, so as to be able to quickly and precisely find the carried object and realize one-time precise docking of the transporting device with the carried object, effectively improving the working efficiency of the whole warehouse. During the whole process, the carried object does not need precise limiting, and even if the position of the carried object is rather deviated from the predetermined position, docking can be smoothly realized in one time without the need of repeated adjustment of the position of the transporting device near the carried object.

### Embodiment 2

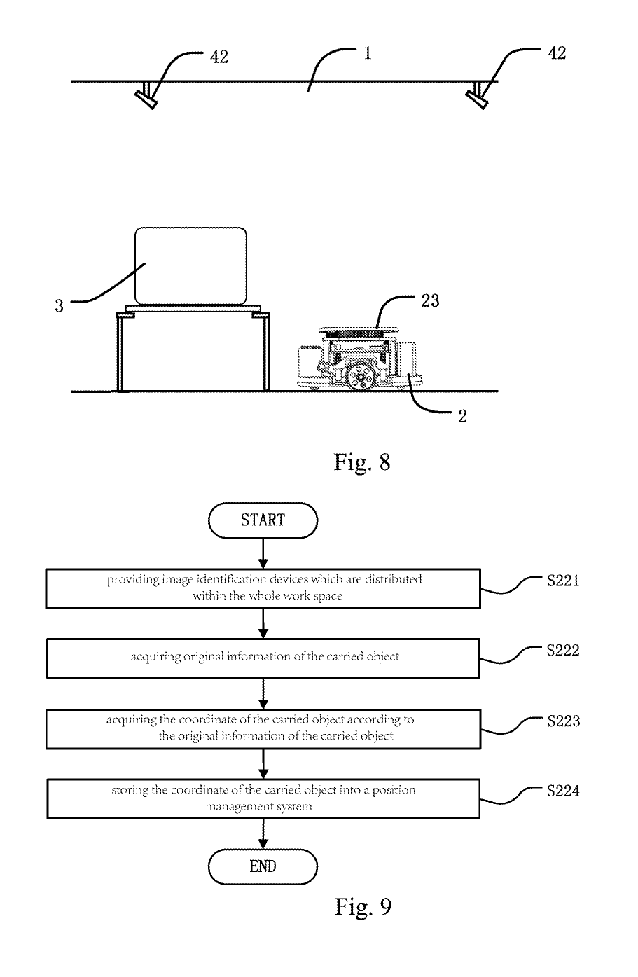

As shown in FIG. 8, Embodiment 2 provides an inventory item management system, including most technical schemes of the inventory item management system in Embodiment 1, with the distinguishing technical features as follows: the carried object identification device 4 is an image identification device 42, used for acquiring the original information of carried object 3; and acquiring the coordinate of at least one carried object according to the original information of carried object 3. Image identification device 42 is provided on the top of work space 1, which can be fixed independently or mounted to a movable pan/tilt, located above the top of carried object 3. Image identification device 42 is a visual sensor including a lens and located above carried object 3; and the original information is at least one image data. Embodiment 2 does not need fiducial marks, and directly uses image data to determine coordinate, which further decreases the hardware cost.

Embodiment 2 provides a method for docking the transporting device with the carried object, including most technical schemes of the method for docking the transporting device with the carried object in Embodiment 1, with the distinguishing technical features as follows: before Step S2), it can also include a method for the position management system acquiring the coordinate of the carried object and sending it to the transporting device, as shown in FIG. 9, specifically including the following steps: Step S221) providing at least one image identification device distributed within the whole work space; Step S222) acquiring original information of the carried object; Step S223) acquiring the coordinate of at least one carried object according to the original information of the carried object; Step S224) storing the coordinate of the carried object into a position management system. In Step S2, the position management system sends the coordinate of the carried object to the transporting device, and the transporting device acquires the coordinate of the carried object within the work space from the position management system.

Step S221)-Step S224) are actually the process of the position management system acquiring the coordinate of carried object 3, utilizing a plurality of evenly distributed visual sensors provided high up in an independent space and the original information (i.e. image data of the cargo and warehouse), effectively identifying the area where each cargo is located in the warehouse, so as to acquire and store the coordinates of all cargos with the fastest speed. For example, the image data can include the images of the carried object and the warehouse that the carried object is located in, and the warehouse can be provided with a warehouse reference numeral or a coordinate, such that, the image identification device can acquire the coordinate of at least one carried object from the original information of the carried object.

The technical effects of Embodiment 2 lie in that, providing an inventory item management system, a transporting device and a method for docking the transporting system with the carried object, which utilize image recognition technology to proceed real-time monitoring of the position of the carried object, such that each carried object in the work space (such as a warehouse) is simultaneously identified and the real position thereof is stored when it is put down, facilitating the transporting device (such as an AGV) to invoke the position of a carried object that is required to be carried at any time when desired. Embodiment 2 enables that the transporting device has sufficient time to set its optimized path, and enables the transporting device to adjust direction autonomously during traveling, rather than traveling to the vicinity of the carried object and then adjusting direction, so as to be able to quickly and precisely find the carried object and realize one-time precise docking of the transporting device with the carried object, effectively improving the working efficiency of the whole warehouse. In comparison with Embodiment 1, the technical scheme of Embodiment 2 does not require fiducial marks, which further decreases the hardware cost.

### Embodiment 3

As shown in FIG. 1, FIG. 2 and FIG. 8, Embodiment 3 provides an inventory item management system, including all technical schemes of the inventory item management system in Embodiment 1 and Embodiment 2, and the hardware structure of Embodiment 3 is identical to that of Embodiment 1 or Embodiment 2, with the distinguishing technical features as below.

The system controller 5 is also used for distributing a transport instruction for transporting carried object 3 within work space 1 to the target position, to transporting device 2. The transport instruction includes the coordinate of the target position, and can also include the information such as the code, shape, etc. of carried object 3.

Control unit 21 is also used for acquiring the transport instruction; acquiring a coordinate of the target position; setting a second optimized path for transporting device 2 traveling from the position of carried object 3 to the target position; distributing at least one second travel instruction according to the second optimized path. Driving unit 22 is also used for driving transporting device 2 to travel to the target position according to the second travel instruction; and docking unit 23 is also used for detaching the carried object to release the docking status.

In control unit 21, communication unit 212 is used for acquiring the transport instruction, and acquiring a coordinate of the target position. Route calculation unit 213 is used for setting the second optimized path according to the coordinate of carried object 3 and a coordinate of the target position; instruction unit 214 is used for sending the second travel instruction to driving unit 22 according to the second optimized path. In route calculation unit 213, topological map invoking unit 2131 is used for invoking a topological map of a work space; the topological map comprising geometrical information and connection relation information of at least one travelable route within the work space. Topological position acquisition unit 3132 is also used for acquiring topological positions of the target position and the transporting device on the topological map; optimized path calculation unit 3133 is also used for calculating a second optimized path for the transporting device traveling to the target position according to the topological positions of the target position and the transporting device, and the geometrical information and connection relation information of the travelable routes.

In instruction calculation unit 214, relative position acquisition unit 2141 is also used for acquiring a relative position relation between the transporting device and the second optimized path according to a real time coordinate of the transporting device and the second optimized path.

Travel instruction calculation unit 2142 is also used for calculating at least one second travel instruction according to the relative position relation; the second travel instruction comprises a speed instruction and an angular speed instruction, or, comprises a speed instruction and a turning radius instruction; travel instruction distribution unit 2143 is also used for distributing the second travel instruction to a driving unit.

In driving unit 22, speed adjustment unit 221 is also used for adjusting the speed of transporting device 2 during traveling according to a speed instruction in the second travel direction instruction. Angular speed adjustment unit 222 is also used for adjusting the angular speed of transporting device 2 during traveling according to an angular speed instruction in the second travel direction instruction; or, the turning radius adjustment unit (not shown in figures) is also used for adjusting the turning radius of transporting device 2 during traveling according to a turning radius instruction in the second travel direction instruction.

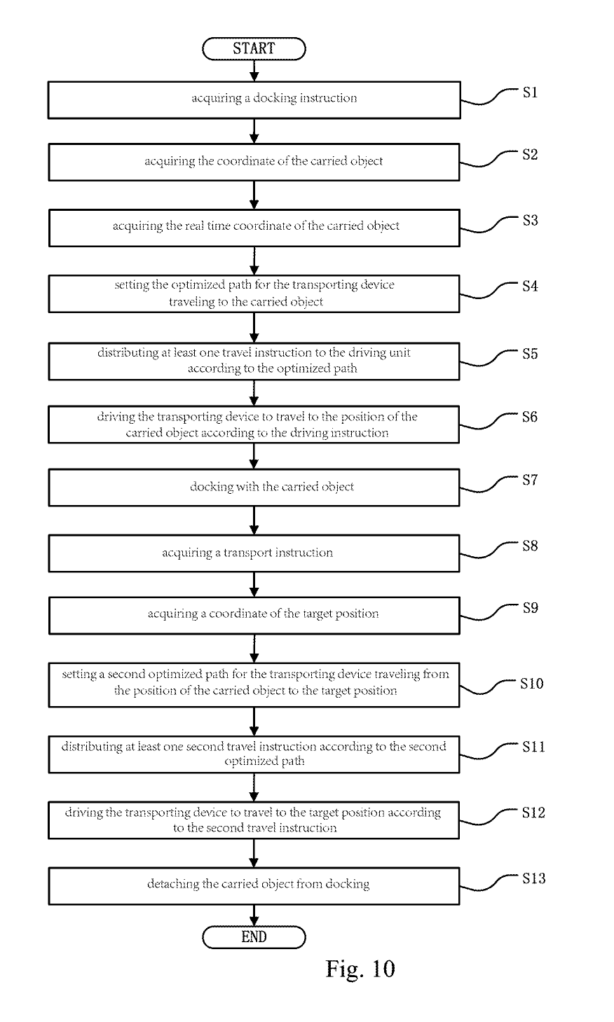

Embodiment 3 provides a method for docking the transporting device with the carried object, including all technical schemes of the method for docking the transporting device with the carried object in Embodiment 1 and Embodiment 2, with the distinguishing technical features lying in that, as shown in FIG. 10, after Step S7—the step of docking with carried object 3, it can also include the steps as below.

Step S8) the transporting device acquires the transport instruction for transporting the carried object to the target position within the work space from the communication unit. The transport instruction includes the coordinate of the target position, and can also include the information such as the code, shape, etc. of carried object 3.

Step S9) acquiring the coordinate of the target position, and acquiring the coordinate of the target position by analyzing the transport instruction.

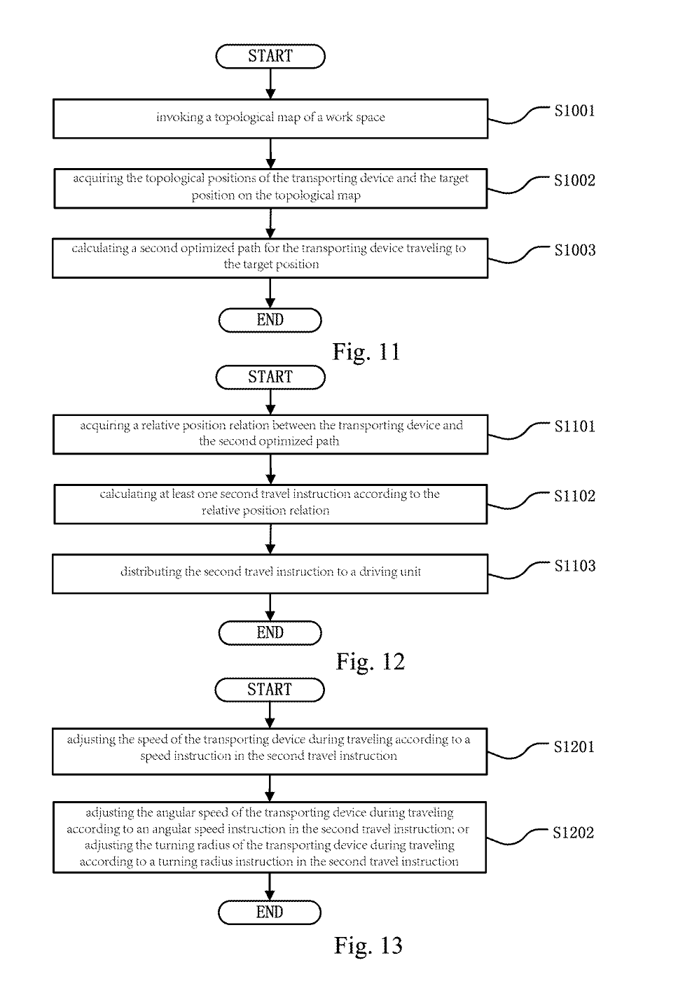

Step S10) setting a second optimized path for the transporting device traveling from the position of the carried object to the target position, as shown in FIG. 11, specifically comprising the following steps: Step S1001) invoking a topological map of a work space; the topological map comprising geometrical information and connection relation information of at least one travelable routes within the work space; Step S1002) acquiring the topological positions of the transporting device and the target position on the topological map; Step S1003) calculating a second optimized path for the transporting device traveling to the target position according to the topological positions of the transporting device and the target position, and the geometrical information and connection relation information of the travelable routes.

Step S11) distributing at least one travel instruction according to the second optimized path, as shown in FIG. 12, specifically comprising the following steps: Step S1101) acquiring a relative position relation between the transporting device and the second optimized path according to a real time coordinate of the transporting device and the second optimized path; Step S1102) calculating at least one second travel instruction according to the relative position relation; the second travel instruction comprising a speed instruction and an angular speed instruction, or, comprising a speed instruction and a turning radius instruction; Step S1103) distributing the second travel instruction to a driving unit.

Step S12) driving the transporting device to travel to the target position according to the second travel instruction, as shown in FIG. 13, specifically comprising the following steps: Step S1201) adjusting the speed of the transporting device during traveling according to a speed instruction in the second travel instruction; Step S1202) adjusting the angular speed of the transporting device during traveling according to an angular speed instruction in the second travel instruction; or adjusting the turning radius of the transporting device during traveling according to a turning radius instruction in the second travel instruction.

Step S13) detaching the carried object, releasing the docking relation and placing the carried object in the target position to complete carrying.

The above Step S8)—Step S13) are continuation of the docking method in Embodiment 1 or 2, and can also be referred to as a method for a transporting device transporting the carried object. In Embodiment 1 or 2, only the docking of the transporting device with the carried object is realized, but in practical production, the cargos need to be removed from one position to another, and the pure docking is meaningless. By adopting the technical scheme in Embodiment 3, the transporting device can be used for transferring a carried object to another target position after docking is completed.

In the process of system controller 5 distributing a control instruction to the transporting device, the docking instruction and the transport instruction can be sent in turn, and can also be sent simultaneously, or even only one transport instruction is sent, which implies a docking instruction therein.

If transporting device 2 first acquires the docking instruction and then acquires the transport instruction, then Step S1)-Step S7) have to be proceeded first; after acquiring the transport instruction, no matter if Step S7) is completed, Step S8)-Step S10) can be proceeded, with no interference between the two procedures; however, Step S11)-Step 13) have to be proceeded after Step S7) is completed.

If transporting device 2 acquires the docking instruction and the transport instruction simultaneously, or only acquires a transport instruction implying a docking instruction, then the two different procedures of Step S1)-S7), Step S8)-S10) can be proceeded synchronously by transporting device 2, with the two realized independently without interference; however, Step S11)-S13) have to be proceeded after Step S7) is completed.

The technical effects of Embodiment 3 lie in that, providing an inventory item management system, a transporting device and a method for docking the transporting system with the carried object, which utilize mark identification technology or image identification technology to proceed real-time monitoring of the position of the carried object, such that each carried object in the work space (such as a warehouse) is simultaneously identified and the real position thereof is stored when it is put down, facilitating the transporting device (such as an AGV) to invoke the position of a carried object that is required to be carried at any time when desired. After the docking of the transporting device with the carried object is completed, the transporting device and the carried object travel together to the target position.

In the process of the transporting device traveling, no matter in the process of traveling to the carried object or in the process of traveling to the target position, the transporting device has sufficient time to set its optimized path, the transporting device can adjust direction autonomously during traveling, rather than traveling to the vicinity of the carried object and then adjusting direction, so as to be able to quickly and precisely find the carried object or the target position, effectively improving the working efficiency of the transporting device. In the whole process, there is no need for precise limit of the carried object, in that even if the position of the carried object is rather deviated from the predetermined position, docking can be smoothly realized in one time without the need of repeated adjustment of the position of the transporting device near the carried object. In comparison with the technical schemes in Embodiment 1 and Embodiment 2, Embodiment 3 is more meaningful in practice, and can be widely promoted and used in the field of storage and logistics.

The preferred specific embodiments of the invention have been described in detail above. It is to be understood that numerous modifications and variations can be made by those ordinary skilled in the art in accordance with the concepts of the present invention without any inventive effort. Therefore, the technical solutions that may be derived by those skilled in the art should be within the scope of protection defined by the claims.

1. A method for docking a transporting device with a carried object, wherein the method comprises the following steps:
acquiring a docking instruction for docking a carried object within a work space;
acquiring a coordinate of the carried object within the work space;
acquiring a real time coordinate of the transporting device within the work space;
setting an optimized path for the transporting device traveling to the carried object;
distributing at least one travel instruction according to the optimized path;
driving the transporting device to travel to the position of the carried object according to the travel instruction; and
docking with the carried object.

2. The method for docking the transporting device with the carried object as claimed in claim 1, wherein the method comprises the following steps before the step of acquiring a coordinate of the carried object:
providing at least one fiducial mark on at least one carried object;
providing at least one fiducial mark identification device distributed within the whole work space;
identifying the fiducial mark and acquiring the coordinate of the carried object, and
storing the coordinate of the carried object into a position management system.

3. The method for docking the transporting device with the carried object as claimed in claim 2, wherein
the fiducial mark is provided on the top of the carried object;
the fiducial mark identification device is provided on the top of the work space, which can be fixed independently or mounted to a pan/tilt, located above the top of the carried object.

4. The method for docking the transporting device with the carried object as claimed in claim 3, wherein
the fiducial mark is a readable code;
the fiducial mark identification device is a visual sensor.

5. The method for docking the transporting device with the carried object as claimed in claim 4, wherein the readable code is a two-dimensional code or a bar code.

6. The method for docking the transporting device with the carried object as claimed in claim 1, wherein the method comprises the following steps before the step of acquiring the coordinate of the carried object:
providing at least one image identification device distributed within the whole work space;
acquiring original information of the carried object;
acquiring the coordinate of at least one carried object according to the original information of the carried object; and
storing the coordinate of the carried object into a position management system.

7. The method for docking the transporting device with the carried object as claimed in claim 6, wherein the image identification device is provided on the top of the work space, which can be fixed independently or mounted to a pan/tilt, located above the top of the carried object.

8. The method for docking the transporting device with the carried object as claimed in claim 7, wherein the image identification device is a visual sensor; and the original information is at least one image data.

9. The method for docking the transporting device with the carried object as claimed in claim 1, wherein the step of acquiring a real time coordinate of the transporting device refers to acquiring a real time coordinate of the transporting device using laser navigation, magnetic navigation or visual navigation.

10. The method for docking the transporting device with the carried object as claimed in claim 1, wherein the step of setting an optimized path for the transporting device traveling to the carried object specifically comprises the following steps:
invoking a topological map of a work space; the topological map comprising geometrical information and connection relation information of travelable routes within the work space;
acquiring the topological positions of the carried object and the transporting device on the topological map; and
calculating the optimized path for the transporting device traveling to the carried object according to the topological positions of the carried object and the transporting device, and the geometrical information and connection relation information of the travelable routes.

11. The method for docking the transporting device with the carried object as claimed in claim 1, wherein the step of distributing at least one travel instruction according to the optimized path specifically comprises the following steps:
acquiring a relative position relation between the transporting device and the optimized path according to a real time coordinate of the transporting device and the optimized path;
calculating at least one travel instruction according to the relative position relation; the travel instruction comprising a speed instruction and an angular speed instruction, or, comprising a speed instruction and a turning radius instruction; and
distributing the travel instruction to a driving unit.

12. The method for docking the transporting device with the carried object as claimed in claim 1, wherein the step of driving the transporting device to travel to the carried object according to the travel instruction specifically comprises the following steps:
adjusting the speed of the transporting device during traveling according to a speed instruction; and
adjusting the angular speed of the transporting device during traveling according to an angular speed instruction; or
adjusting the turning radius of the transporting device during traveling according to a turning radius instruction.

13. The method for docking the transporting device with the carried object as claimed in claim 1, wherein in the step of docking with the carried object, the transporting device is docked with the carried object by lifting; and/or is docked with the carried object by articulating.

14. The method for docking the transporting device with the carried object as claimed in claim 1, wherein the method comprises the following steps after the step of docking with the carried object:
acquiring a transport instruction for transporting the carried object to a target position within the work space;
acquiring a coordinate of the target position;
setting a second optimized path for the transporting device traveling from the position of the carried object to the target position;
distributing at least one second travel instruction according to the second optimized path;
driving the transporting device to travel to the target position according to the second travel instruction; and
detaching the carried object.

15. The method for docking the transporting device with the carried object as claimed in claim 14, wherein the step of setting a second optimized path for the transporting device traveling from the position of the carried object to the target position specifically comprises the following steps:
invoking a topological map of a work space, the topological map comprising geometrical information and connection relation information of at least one travelable route within the work space;
acquiring the topological positions of the transporting device and the target position on the topological map; and
calculating the second optimized path for the transporting device traveling to the target position according to the topological positions of the transporting device and the target position, and the geometrical information and connection relation information of the travelable routes.

16. The method for docking the transporting device with the carried object as claimed in claim 14, wherein the step of distributing at least one travel instruction according to the second optimized path specifically comprises the following steps:
acquiring a relative position relation between the transporting device and the second optimized path according to a real time coordinate of the transporting device and the second optimized path;
calculating at least one second travel instruction according to the relative position relation; the second travel instruction comprising a speed instruction and an angular speed instruction, or, comprising a speed instruction and a turning radius instruction; and
distributing the second travel instruction to a driving unit.

17. The method for docking the transporting device with the carried object as claimed in claim 14, wherein the step of driving the transporting device to travel to the position of the carried object according to the second travel instruction specifically comprises the following steps:
adjusting the speed of the transporting device during traveling according to a speed instruction in the second travel instruction; and
adjusting the angular speed of the transporting device during traveling according to an angular speed instruction in the second travel instruction; or
adjusting the turning radius of the transporting device during traveling according to a turning radius instruction in the second travel instruction.

18. The method for docking the transporting device with the carried object as claimed in claim 1, wherein
the work space comprises a warehouse;
the carried object comprises an inventory holder or a tray;
the transporting device comprises an automated guided vehicle or a mobile robot.

19. A transporting device, wherein transporting device comprises:
a control unit, used for
acquiring a docking instruction for docking a carried object within a work space;
acquiring a coordinate of the carried object;
acquiring a real time coordinate of the transporting device;
setting an optimized path for the transporting device traveling to the carried object; and
distributing at least one travel instruction according to the optimized path;
a driving unit, used for
driving the transporting device to travel to the carried object according to the travel instruction;
a docking unit, used for
docking with the carried object.

20. The transporting device as claimed in claim 19, wherein the control unit is also used for
acquiring a transport instruction for transporting the carried object to a target position within the work space;
acquiring a coordinate of the target position;
setting a second optimized path for the transporting device traveling from the position of the carried object to the target position;
distributing at least one second travel instruction according to the second optimized path;
the driving unit is also used for
driving the transporting device to travel to the target position according to the second travel instruction;
the docking unit is also used for
detaching the carried object.

21. The transporting device as claimed in claim 19, wherein the control unit comprises:
a navigation unit, used for
acquiring a real time coordinate of the transporting device;
a communication unit, used for
acquiring the docking instruction and/or the transport instruction,
acquiring a coordinate of the carried object and/or a coordinate of the target position; and
a route calculation unit, used for
setting the optimized path according to the coordinate of the carried object and a real time coordinate of the transporting device; or,
setting the second optimized path according to the coordinate of the carried object and the coordinate of the target position;
an instruction unit, used for
sending the travel instruction to the driving unit according to the optimized path; or, sending the second travel instruction to the driving unit according to the second optimized path.

22. The transporting device as claimed in claim 21, wherein the navigation unit comprises a laser navigation unit, a magnetic navigation unit or a visual navigation unit.

23. The transporting device as claimed in claim 21, wherein the route calculation unit comprises:
a topological map invoking unit, used for
invoking a topological map of a work space; the topological map comprising geometrical information and connection relation information of at least one travelable route within the work space;
a topological position acquisition unit, used for
acquiring the topological positions of the carried object or the target position and the transporting device on the topological map;
an optimized path calculation unit, used for
calculating the optimized path for the transporting device traveling to the carried object according to the topological positions of the carried object and the transporting device, and the geometrical information and connection relation information of the travelable routes; or
calculating a second optimized path for the transporting device traveling to the target position according to the topological positions of the target position and the transporting device, and the geometrical information and connection relation information of the travelable routes.

24.-25. (canceled)

26. The transporting device as claimed in claim 21, wherein the docking unit comprises:
a lifting device, for docking with the carried object by lifting; and/or
an articulating device, for docking with the carried object by articulating.

27. The transporting device as claimed in claim 21, wherein
the work space comprises a warehouse;
the carried object comprises an inventory holder or a tray;
the transporting device comprises an automated guided vehicle or a mobile robot.

28. An inventory item management system, comprising:
a work space;
a transporting device according to claim 21;
a system controller, connected to a communication unit of the transporting device; used for distributing the docking instruction and/or the transport instruction to the communication unit;
at least one carried object, located within the work space;
at least one carried object identification device, distributed within the whole work space, used for identifying the coordinate of at least one carried object; and
a position management system, connected to the carried object identification device and the communication unit, used for storing the coordinate of the carried object, and sending the coordinate of the carried object to the communication unit.

29. The inventory item management system as claimed in claim 28, wherein
each carried object is provided with at least one fiducial mark;
the carried object identification device is a fiducial mark identification device, used for identifying the fiducial mark, and acquiring the coordinate of at least one carried object according to the information carried by the fiducial mark.

30. The inventory item management system as claimed in claim 29, wherein
the fiducial mark is provided on the top of the carried object;
the fiducial mark identification device is provided on the top of the work space, which can be fixed independently or mounted to a pan/tilt, located above the top of the carried object.

31. The inventory item management system as claimed in claim 30, wherein
the fiducial mark is a readable code;
the fiducial mark identification device is a visual sensor.

32. The inventory item management system as claimed in claim 31, wherein the readable code is a two-dimensional code or a bar code.

33. The inventory item management system as claimed in claim 28, wherein the carried object identification device is an image identification device, used for
acquiring original information of the carried object; and
acquiring the coordinate of at least one carried object according to the original information of the carried object.

34. The inventory item management system as claimed in claim 33, wherein the image identification device is provided on the top of the work space, which can be fixed independently or mounted to a pan/tilt, located above the top of the carried object.

35. The inventory item management system as claimed in claim 34, wherein the image identification device is a visual sensor; and the original information is at least one image data.

36. The transporting device as claimed in claim 20, wherein the control unit comprises:
a navigation unit, used for
acquiring a real time coordinate of the transporting device;
a communication unit, used for
acquiring the docking instruction and/or the transport instruction,
acquiring a coordinate of the carried object and/or a coordinate of the target position; and
a route calculation unit, used for
setting the optimized path according to the coordinate of the carried object and a real time coordinate of the transporting device; or,
setting the second optimized path according to the coordinate of the carried object and the coordinate of the target position;
an instruction unit, used for
sending the travel instruction to the driving unit according to the optimized path; or, sending the second travel instruction to the driving unit according to the second optimized path.

37. The transporting device as claimed in claim 36, wherein the navigation unit comprises a laser navigation unit, a magnetic navigation unit or a visual navigation unit.

38. The transporting device as claimed in claim 36 wherein the route calculation unit comprises:
a topological map invoking unit, used for
invoking a topological map of a work space; the topological map comprising geometrical information and connection relation information of at least one travelable route within the work space;
a topological position acquisition unit, used for
acquiring the topological positions of the carried object or the target position and the transporting device on the topological map;
an optimized path calculation unit, used for
calculating the optimized path for the transporting device traveling to the carried object according to the topological positions of the carried object and the transporting device, and the geometrical information and connection relation information of the travelable routes; or
calculating a second optimized path for the transporting device traveling to the target position according to the topological positions of the target position and the transporting device, and the geometrical information and connection relation information of the travelable routes.

39. An inventory item management system, comprising:
a work space;
a transporting device according to claim 22;
a system controller, connected to a communication unit of the transporting device; used for distributing the docking instruction and/or the transport instruction to the communication unit;
at least one carried object, located within the work space;
at least one carried object identification device, distributed within the whole work space, used for identifying the coordinate of at least one carried object; and
a position management system, connected to the carried object identification device and the communication unit, used for storing the coordinate of the carried object, and sending the coordinate of the carried object to the communication unit.

40. The inventory item management system as claimed in claim 39, wherein
each carried object is provided with at least one fiducial mark;
the carried object identification device is a fiducial mark identification device, used for identifying the fiducial mark, and acquiring the coordinate of at least one carried object according to the information carried by the fiducial mark.

41. The inventory item management system as claimed in claim 39, wherein
the fiducial mark is provided on the top of the carried object;
the fiducial mark identification device is provided on the top of the work space, which can be fixed independently or mounted to a pan/tilt, located above the top of the carried object.

42. The inventory item management system as claimed in claim 41, wherein
the fiducial mark is a readable code;
the fiducial mark identification device is a visual sensor.

43. The inventory item management system as claimed in claim 42, wherein the readable code is a two-dimensional code or a bar code.

44. The inventory item management system as claimed in claim 39, wherein the carried object identification device is an image identification device, used for
acquiring original information of the carried object; and
acquiring the coordinate of at least one carried object according to the original information of the carried object.

45. The inventory item management system as claimed in claim 44, wherein the image identification device is provided on the top of the work space, which can be fixed independently or mounted to a pan/tilt, located above the top of the carried object.

46. The inventory item management system as claimed in claim 45, wherein the image identification device is a visual sensor; and the original information is at least one image data.

47. The transporting device as claimed in claim 36, wherein the instruction unit comprises
a relative position acquisition unit, used for
acquiring a relative position relation between the transporting device and the optimized path according to a real time coordinate of the transporting device and the optimized path; or
acquiring a relative position relation between the transporting device and the second optimized path according to a real time coordinate of the transporting device and the second optimized path;
a travel instruction calculation unit, used for
calculating at least one travel instruction or second travel instruction according to the relative position relation;
the travel instruction or the second travel instruction comprising a speed instruction and an angular speed instruction, or, comprising a speed instruction and a turning radius instruction; and
a travel instruction distribution unit, used for distributing the travel instruction or the second travel instruction to a driving unit.

48. The transporting device as claimed in claim 36, wherein the driving unit comprises:
a speed adjustment unit, used for adjusting the speed of the transporting device during traveling according to a speed instruction in the second travel instruction; and
an angular speed adjustment unit, used for adjusting the angular speed of the transporting device during traveling according to an angular speed instruction in the second travel instruction; or,
a turning radius adjustment unit, used for adjusting the turning radius of the transporting device during traveling according to a turning radius instruction in the second travel instruction.
